(19) United States
(12) Patent Application Publication
(10) Pub. No.: US 2024/0083049 A1
(43) Pub. Date: Mar. 14, 2024

(54) COVER AND STAND FOR PERSONAL CARE PRODUCT

(71) Applicant: The Gillette Company LLC, Boston, MA (US)

(72) Inventors: Patrick Duncan McEwen, Reading (GB); Robert Andrew Kearney, Reading (GB); Mark Peterson, Reading (GB)

(21) Appl. No.: 18/243,195

(22) Filed: Sep. 7, 2023

Related U.S. Application Data
(60) Provisional application No. 63/405,070, filed on Sep. 9, 2022.

(51) Int. Cl. B26B 21/40; A45D 27/29

(52) U.S. Cl. CPC B26B 21/4037; A45D 27/29

(57) ABSTRACT

A personal care product is provided including an applicator head with a flat treatment sheet. The personal care product also includes a cover configured to surround the applicator head and to cover the treatment sheet. The cover includes a base with a planar outer surface. The cover also includes an outer rim around a perimeter of the planar outer surface and an inner rim configured to engage a portion of the applicator head. The planar outer surface of the base defines a plane. The personal care product includes a center of gravity with a projection in the plane, where the length of the one or more tabs along the plane exceeds a length between the projection and the inner rim along the plane.

### FIELD OF THE INVENTION

The present invention relates to a cover for use with a personal care product having a treatment sheet to protect the treatment sheet during periods of non-use and to serve as a stand.

### BACKGROUND OF THE INVENTION

In general, personal care products include an applicator head with a treatment sheet where the treatment sheet includes at least one cutting element which is moved across the surface of the skin being treated by means of a handle to which the applicator head is attached. The applicator head may be mounted detachably on the handle to enable the applicator head to be replaced by a fresh applicator head when the treatment sheet sharpness has diminished to an unsatisfactory level, or it may be attached permanently to the handle with the intention that the entire personal care product be discarded when the treatment sheet has become dulled (i.e., disposable personal care product).

Various types of protective covers have been utilized with commercially available razor products that are either detachably or permanently mounted to a handle. These covers may serve several purposes. First, the cover protects the razor cartridges and the blade edges during the different stages of shipping and retailing from forces which may damage the blade edges. Secondly, the cover also protects a user from unintentionally encountering the sharp blade or blades when the razor is not in use. Additionally, conventional covers are known which act as a support to stand a bottom or distal end (opposite to the end holding a razor or cutting surface) of the personal care product on a horizontal surface.

However, razor product covers tend to require a high force to remove the cover or put the cover back on which brings the consumer's fingers too close to the blade edges or could cause damage to the blade edges.

Additionally, the covers of the prior art generally do not assist in the drying of the cartridge, nor the drainage of water and other debris, nor do they serve a purpose beyond those noted above. Further, these covers are not adequate for personal care products which do not have razor blades but rather other types of cutting elements, e.g., treatment sheet, non-linear cutting edges.

Some personal care products feature a treatment sheet that is slanted at a non-orthogonal angle relative to the handle of the personal care product. To facilitate storage and ease of location of the personal care product, it would be beneficial to stand the personal care product on flat surfaces. However, covers of the prior art tend to feature curved outer surfaces which do not facilitate standing these personal care products on flat surfaces. Additionally, even those covers of the prior art which do feature flat surfaces are not configured to stand personal care products with the slanted treatment sheet design on a flat surface.

### SUMMARY OF THE INVENTION

It is an object of the present invention to provide a protective cover for a personal care product which not only protects the treatment sheet during periods of non-use and allows for easy removal and placement on the applicator head, but also serves advantageously to allow drainage and serve as a stand for the personal care product. Particularly, the protective cover can serve as a stand that supports a top end or end of the personal care product holding a razor or cutting surface.

It is a further object of the present invention to provide a protective cover for a personal care product which facilitates standing the personal care product on a flat surface, particularly personal care products which feature a slanted treatment sheet oriented at a non-orthogonal angle relative to a handle of the personal care product.

More specifically, various embodiments relate to a personal care product including an applicator head with a flat treatment sheet. The personal care product also includes a cover configured to surround the applicator head and to cover the treatment sheet. The cover includes a base with a planar outer surface. The cover also includes an outer rim around a perimeter of the planar outer surface and an inner rim configured to engage a portion of the applicator head.

More specifically, various embodiments relate to a personal care product including an applicator head with a flat treatment sheet. The personal care product also includes a cover configured to surround the applicator head and to cover the treatment sheet. The cover includes a base with a planar outer surface that defines a plane that is parallel to the planar outer surface. The cover also includes an outer rim around a perimeter of the planar outer surface and an inner rim configured to frictionally engage a portion of the applicator head. The cover also includes one or more tabs integral with the cover and extending along the plane by a length beyond the inner rim. The personal care product includes a center of gravity with a projection in the plane, where the length of the one or more tabs along the plane exceeds a length between the projection and the inner rim along the plane.

More specifically, various embodiments relate to a cover for an applicator head of a personal care product. The cover includes a first portion with a planar outer surface. The cover further includes a second portion including a cavity. The cover further includes a third portion with an inner rim around a portion of a perimeter of the cavity. The inner rim is configured to frictionally engage the applicator head of the personal care product when the applicator head is disposed in the cavity. The cover further includes a fourth portion comprising one or more planar tabs protruding beyond the inner rim.

### BRIEF DESCRIPTION OF THE DRAWINGS

FIGS. 1A and 1B are perspective front and side views of one possible embodiment of a personal care product, according to the present invention;

FIG. 1C is a cross-sectional side view of one possible embodiment of a housing, a frame and applicator head of a personal care product, according to the present invention;

FIGS. 2A and 2B are top and bottom views of one possible embodiment of a cover for a personal care product, according to the present invention;

FIGS. 2C and 2D are top and bottom perspective views of one possible embodiment of a cover for a personal care product, according to the present invention;

FIGS. 3A and 3B are cross-sectional side views of possible embodiments of a cover for a personal are product, according to the present invention;

FIG. 3C is a cross-sectional side view of one possible embodiment of a cover for a personal are product, according to the present invention;

FIG. 3D is a cross-sectional side view of one possible embodiment of a cover for a personal are product, according to the present invention;

FIGS. 3E and 3F are top views of possible embodiments of a cover for a personal care product, according to the present invention;

FIGS. 3G and 3H are side perspective views of possible embodiments of a cover for a personal care product, according to the present invention;

FIG. 4 is a side view of the applicator head cover of FIGS. 2A through 2D being used as a stand for a personal care product having a handle and an applicator head, according to the present invention;

FIGS. 5A and 5B are side cross-sectional views of the applicator head cover and the personal care product of FIG. 4, according to the present invention; and

FIG. 5C is a side cross-sectional view showing a gap between the applicator head cover and the personal care product of FIG. 4, according to the present invention.

### DETAILED DESCRIPTION OF THE INVENTION

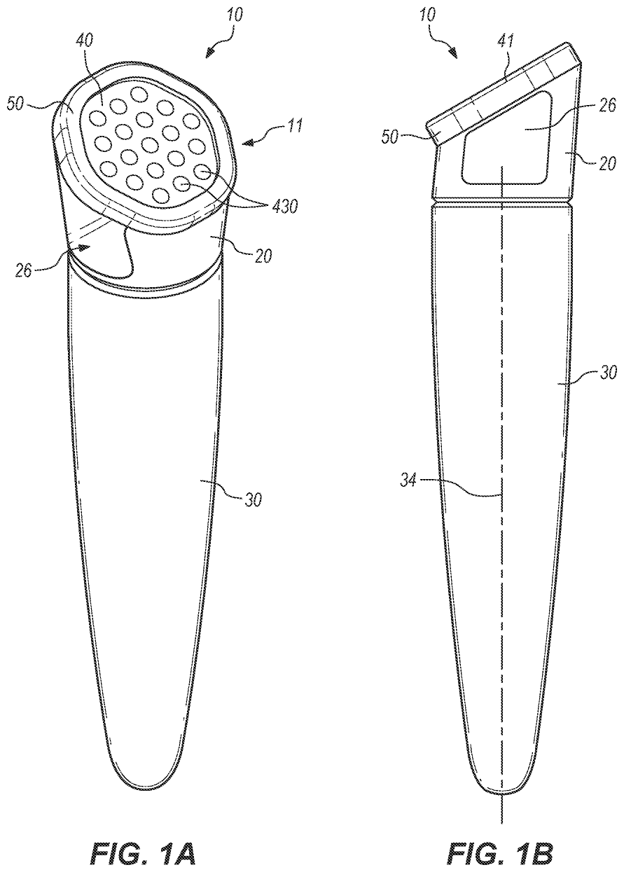

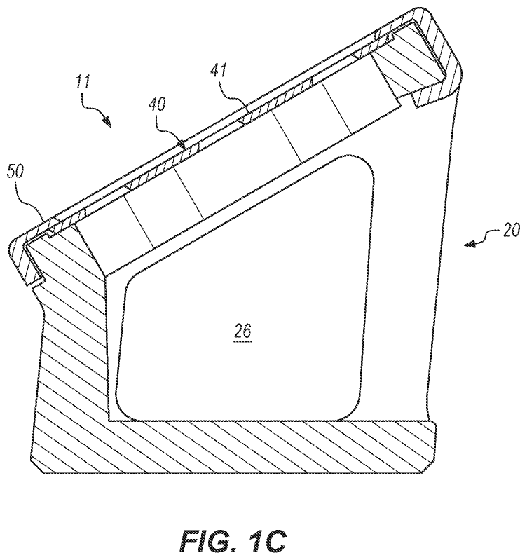

FIGS. 1A and 1B are perspective front and side views of one possible embodiment of a personal care product 10, according to the present invention. In an embodiment, the personal care product 10 includes an applicator head 11 which includes a flat treatment sheet 40. The personal care product 10 also includes a housing 20 that has one or more windows 26. In some embodiments, the applicator head 11 is removable from the personal care product 10. In other embodiments, the applicator head 11 includes the housing 20 with the one or more windows 26.

As shown in FIG. 1B, in one embodiment the personal care product 10 also includes a handle 30. In some embodiments, the handle 30 is arranged such that an axis 34 of the handle 30 is not perpendicular to a top surface 41 of the treatment sheet 40, the axis 34 of the handle 30 is not parallel to the top surface 41 of the treatment sheet 40 or both.

In some embodiments, the personal care product 10 is configured such that the applicator head 11 is applied to a skin surface for removal of hairs and treatment of skin.

In some embodiments, a weight of the personal care product 10 varies from about 10 grams to about 50 grams.

In an embodiment, the personal care product 10 includes the treatment sheet 40 and a frame 50 whereby the frame 50 retains and aligns the treatment sheet 40 for optimal use and performance on the skin.

For purposes of this description, the term “frame” as used herein refers to the component on the personal care product 10 utilized in retaining the treatment sheet 40 to an upper surface of the housing 20 of the personal care product 10. The frame 50 of the present invention is preferably comprised of interconnected segments that connect to form a singular or unitary element having no distal ends. The frame 50 of the present invention can be comprised of any material including but not limited to aluminum, stainless steel, or plastic.

The housing 20 of the personal care product comprises an opening (not shown) at the top and the treatment sheet 40 is disposed to cover the opening of the housing 20. The treatment sheet 40 comprises a plurality of apertures 430. The apertures 430 may comprise straight and non-straight sections along the inner perimeter of each aperture 430. Portions of the inner perimeter of each aperture 430 are sharpened to provide a cutting edge. More durable cutting edges can be produced from materials like ceramic or crystals like silicon, sapphire or diamond. These materials are not ductile like metal and often are brittle, so they cannot be formed into e.g., domed or convex shape, but are available in planar sheets. The planar treatment sheets 40 offer the additional advantage over personal care products in the prior art in that a planar treatment sheet type surface increases the treatment efficiency, such as the removal of hair, or planing of skin on extended flat surfaces of skin such as legs, chest or back.

The frame 50 of the present invention also provides a skin contacting upper surface. The frame 50 has an outer perimeter greater than the outer perimeter of the treatment sheet 40 and an inner perimeter smaller than the outer perimeter of the treatment sheet 40. Tabs along the outer surface of the frame 50 secure the treatment sheet 40 to the housing 20 so that the frame 50 covers the outer perimeter and frames the treatment sheet 40. The frame 50 holds the treatment sheet 40 in place so that the treatment sheet 40 is not displaced relative to the housing 20 as the product 10 is moved around on the skin to exfoliate skin or cut hairs. The frame 50 has a skin contacting surface that is raised above the upper surface of the treatment sheet 40 to control the flow of the skin over the surface of the treatment sheet 40 that comprises the apertures 430. The skin contacting surface of the frame 50 may be flat, rounded, or chamfered. The frame 50 provides an interface or mating surface with the treatment sheet 40 to mechanically stabilize the treatment sheet 40. It has been found that the height difference between the skin contacting surface of the frame 50 and the surface of the treatment sheet 40 maintains safe skin flow over the product 10 and good contact with the skin surface for efficient treatment and that tight mechanical clamping between the frame 50 and the treatment sheet 40 cannot otherwise be achieved with prior art solutions such as adhesives or plastic hooks into slots.

The term “treatment sheet” in the personal care product of the present invention refers to a planar sheet 40 comprising the plurality of apertures 430. Portions of the periphery or perimeter of the apertures 430 comprise cutting edges, used for removing hair and exfoliation or other treatments on skin.

The treatment sheet 40 is desirably flat. A “flat” material generally has planar surfaces without protrusions or indentations. As used herein, “flat” and “planar” can be used interchangeably.

The treatment sheet 40 is also desirably rigid. A “rigid” material signifies that the material is not flexible and cannot be easily bent.

The function of the treatment sheet 40 in the personal care product 10 is to both remove hair and to treat the skin and this is achieved by the structure of the treatment sheet 40.

The treatment sheet 40 of the present invention is desirably comprised of a solid, non-corroding material. The treatment sheet 40 can be comprised of amorphous materials such as glass, crystalline materials such as silicon, diamond, sapphire, polycrystalline materials such as silicon, ceramic, or metals (e.g., steel), or any combination thereof. These materials can be shaped into rigid planar treatment sheets with apertures.

Preferably, the treatment sheet 40 substrate is comprised of a silicon material and the cutting edges are comprised of a diamond material.

The shape of the frame 50 preferably matches the shape of the outer perimeter of the treatment sheet 40, but slightly larger.

While the treatment sheet 40 is desirably comprised of a rigid (e.g., not bendable) material, the frame 50 of the present invention is desirably comprised of a material that can be formed and shaped without breaking and retains its shape after bending.

Any permutations of shapes of the treatment sheet 40, the frame 50, the apertures 430, and sizes thereof are contemplated in the present invention. Moreover, any feasible pattern and location of apertures 430 is also contemplated in the present invention.

The term “about” as used herein generally signifies approximately or around. When a range of numerals are given, e.g., “about 4 to about 40” is disclosed herein, the present invention contemplates +/−10 percent of each number. Thus, for clarity, if a reference is described as being “about 4 to about 40” signifies the range of “3.6 to 44” as being encompassed by the present invention since the range of 3.6 to 4.4 represents +/−10 percent of 4 and the range of 36 to 44 represents +/−10 percent of 40.

FIG. 1C is a cross-sectional side view of one possible embodiment of the housing 20, the frame 50 and the applicator head 11 of the personal care product 10, according to the present invention. As shown in FIGS. 1A through 1C, in one embodiment the frame 50 surrounds the treatment sheet 40 and the handle 30 is joined to the housing 20. In another embodiment, the frame 50 surrounds the treatment sheet 40 and the handle 30 is joined to the frame 50.

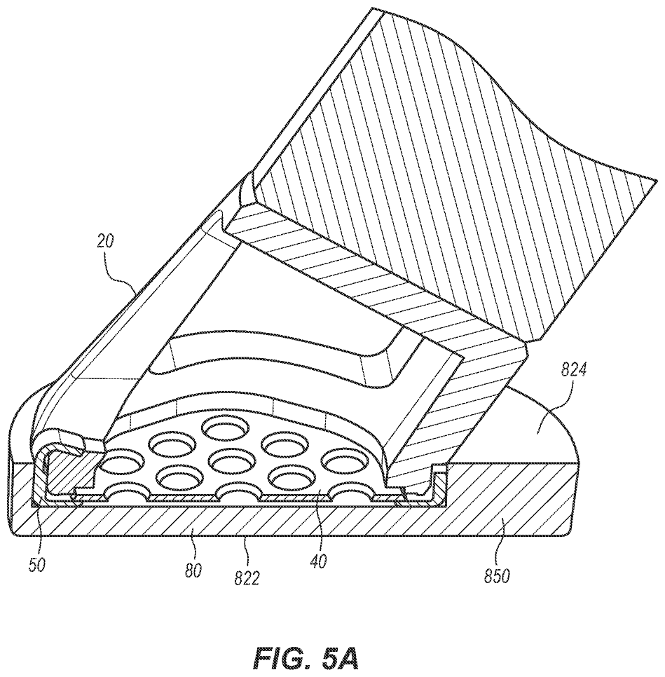

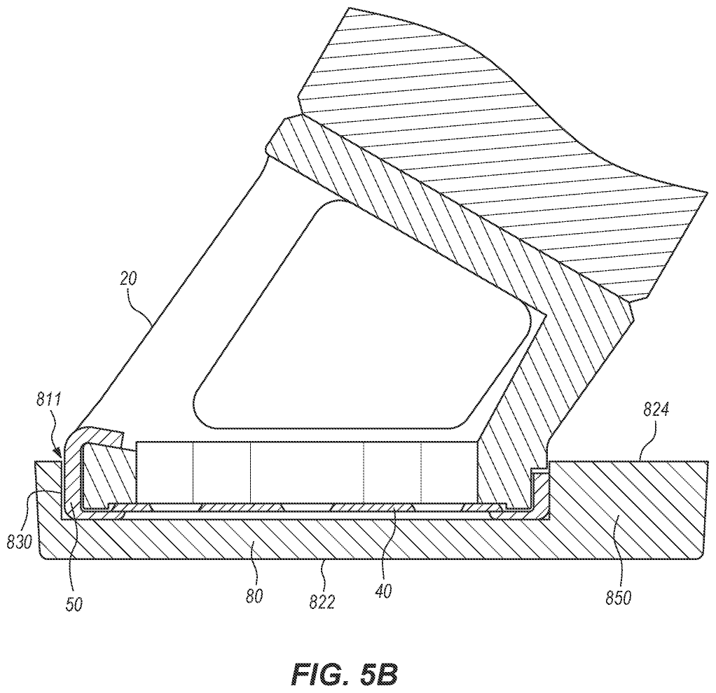

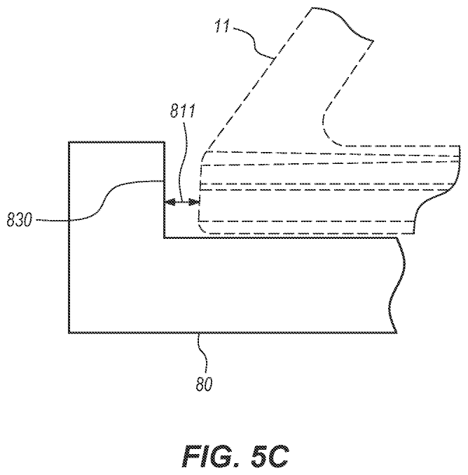

The treatment sheet 40 according to the present invention is shown in FIGS. 1A through 1C and FIG. 5A. A hexagonal shaped treatment sheet 40 is shown, though any shape (e.g., round) is contemplated in the present invention. A cross-sectional view of the treatment sheet 40 is shown in FIG. 1C. The treatment sheet 40 comprises the top surface 41, an outer perimeter, and a plurality of apertures 430. The top surface 41 is a skin contacting surface when the treatment sheet 40 is disposed in a personal care product 10 (e.g., see FIGS. 1A through 1C). The apertures 430 are arranged such that they do not extend to the perimeter of the treatment sheet 40. As shown in FIG. 1A, the apertures 430 have a round or circular shape, though apertures 430 are contemplated to be any feasible shape.

Referring to FIG. 1A a front view of the personal care product 10 is shown having the frame 50 of the present invention disposed over the treatment sheet 40. The personal care product 10 also includes the housing 20, upon which the treatment sheet 40 and frame 50 are disposed. The handle 30 allows the user to hold the product 10 in the hand.

The housing 20 may be permanently attached to the handle 30 or the housing 20 may be releasable from the handle 30. Housing windows 26 are open areas provided in the housing 20 and preferably formed in the housing wall. The housing windows 26 serve as an aid in rinsing the debris produced or accumulated during use of the personal care product 10. Debris may include dead skin cells, hairs (e.g., including vellus hair), treatment or shave preparations, dirt, oils, and other matter removed from the outer surface of the skin or applied to the surface of the skin during use.

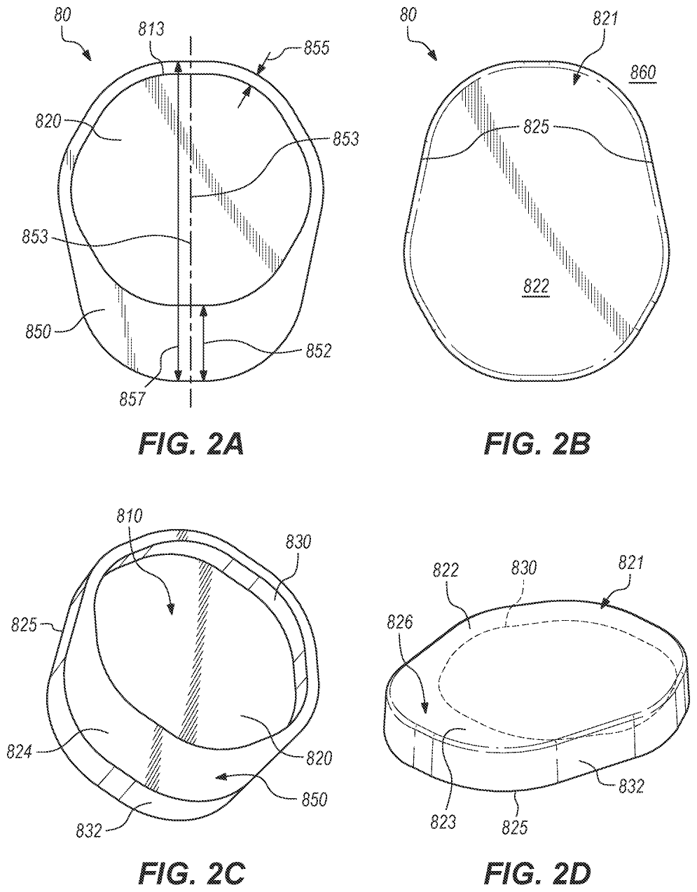

A cover will now be discussed that can be used with the personal care product 10. FIGS. 2A and 2B are top and bottom views of one possible embodiment of a cover 80 for a personal care product, according to the present invention. FIGS. 2C and 2D are top and bottom perspective views of one possible embodiment of a cover 80 for a personal care product, according to the present invention. In some embodiments, the cover 80 is for the personal care product 10 disclosed in FIGS. 1A through 1C. In other embodiments, the cover 80 is disposed for personal care products other than depicted in FIGS. 1A through 1C. In these other embodiments, the personal care product features one or more common characteristics with the personal care product 10 (e.g., a flat treatment sheet secured to a housing of the personal care product, a non-orthogonal angle between an axis of the handle and a direction normal to the flat treatment sheet surface, etc.).

As shown in FIGS. 2A through 2D, the cover 80 includes a base 821 with a planar outer surface 822. The cover 80 also includes an outer rim 832 that extends around a perimeter 825 of the planar outer surface 822. The cover 80 also includes an inner rim 830 configured to engage (e.g., frictionally engage) a portion of the applicator head 11 (e.g., frame 50) when the applicator head 11 is received within a cavity 810 of the cover 80. A rim thickness 855 between the inner rim 830 and the outer rim 832 is about 0.8 mm or in a range from about 0.2 mm to about 2 mm. In these embodiments, the cover 80 is configured to surround this portion of the applicator head 11 and to cover the treatment sheet 40.

As further shown in FIGS. 2A through 2D, in some embodiments the cover 80 includes one or more tabs 850 that are integral with the cover 80 and extend beyond the inner rim 830. In an embodiment, the tab 850 has one or more dimensions including a tab length 852. In one embodiment, the tab length 852 of the tab 850 is measured from the inner rim 830 to the outer rim 832 along a cover axis 853 that bisects the cover 80 into symmetrical sections. In an example embodiment, the tab length 852 is about 16 millimeters (mm) or in a range from about 3 mm to about 30 mm and preferably in a range from about 5 mm to about 20 mm. A total length 857 of the cover 80 along the cover axis 853 is about 25 mm or in a range from about 15 mm to about 35 mm.

As further shown in FIGS. 2A through 2D, the cover 80 has a planar inner surface 820, such that the planar inner surface 820 and the inner rim 830 define a cavity 810 that is configured to receive a portion of the applicator head 11 (e.g., frame 50). In some embodiments, the planar inner surface 820 takes a polygon shape or a substantially circular shape.

In some embodiments, the inner rim 830 and the outer rim 832 are formed such that at least one of the inner rim 830 and outer rim 832 are oriented perpendicular to the planar outer surface 822 of the cover 80. For purposes of this description, “perpendicular” means at an angle between about 85 degrees and about 95 degrees and/or between about 80 degrees and about 100 degrees.

In some embodiments, the cover 80 (e.g., including the tab 850) is made from a rigid plastic or metal material. In some example embodiments, the cover 80 is injection molded or thermoformed from a polymer material, including but not limited to, poly vinyl chloride (PVC), polyethylene terephthalate (PET), high density polyethylene (HDPE), and low-density polyethylene (LDPE), polypropylene (PP), or any combination thereof. However, the cover 80 is not limited to these materials and can be formed with any material that would be recognized by one of ordinary skill in the art to effectuate the frictional engagement with the applicator head 11. As shown in FIGS. 2A through 2D, in some embodiments the cover 80 is one-piece having no hinges, springs, or movable components.

As shown in FIG. 2D, in some embodiments the tab 850 includes a tab base 826 which defines a first tab surface 823 that is coplanar with the planar outer surface 822 of the cover base 821.

In some embodiments, the cover 80 is made of multiple portions. A first portion of the cover 80 includes the planar outer surface 822. A second portion of the cover 80 defines the cavity 810 (e.g., the inner rim 830 and planar inner surface 820). A third portion of the cover 80 includes the inner rim 830 that extends around a perimeter 813 of the cavity 310, where the inner rim 830 is configured to frictionally engage the applicator head 11 (e.g., frame 50) when the applicator head 11 is disposed in the cavity 810. A fourth portion of the cover 80 includes the one or more tabs 850 that protrude beyond the inner rim 830. In one embodiment, the first portion, the second portion, the third portion and the fourth portion are integrally formed (e.g., injection molded or thermoformed from a polymer material).

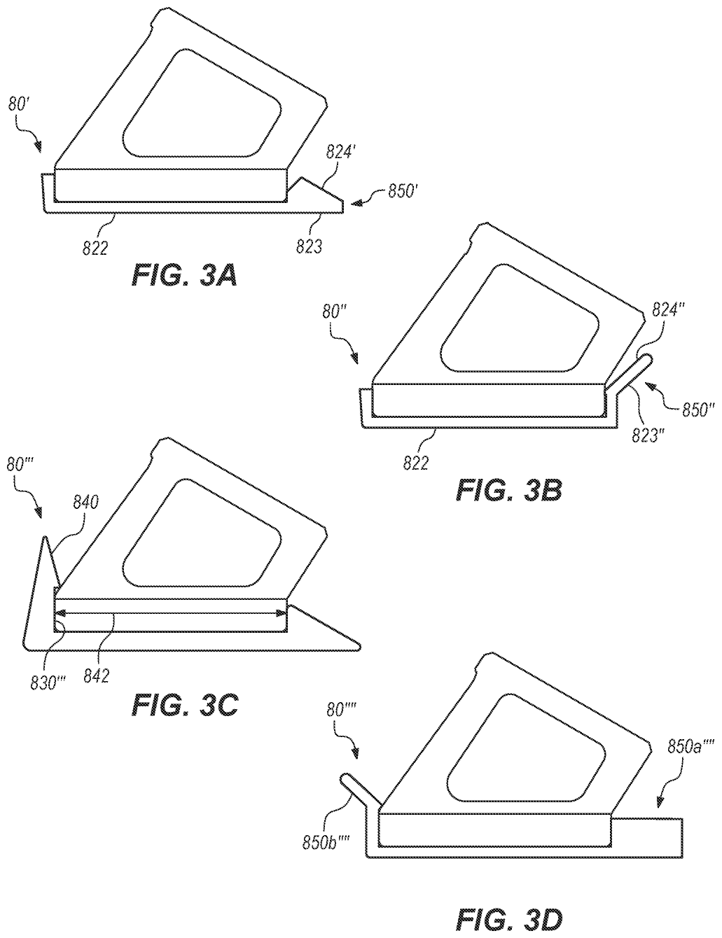

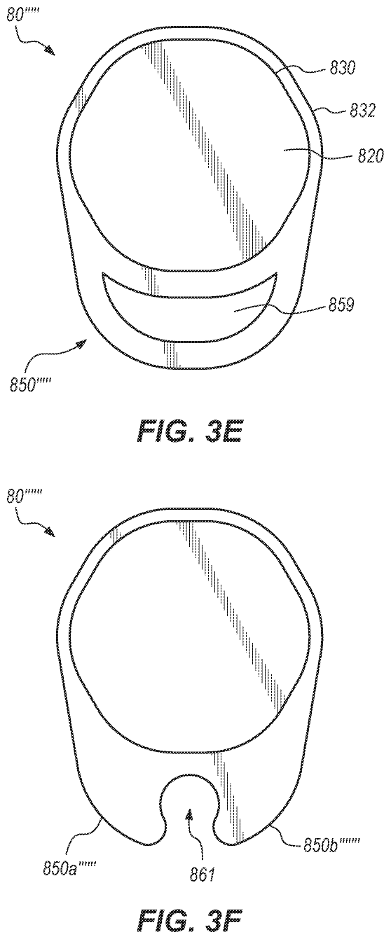

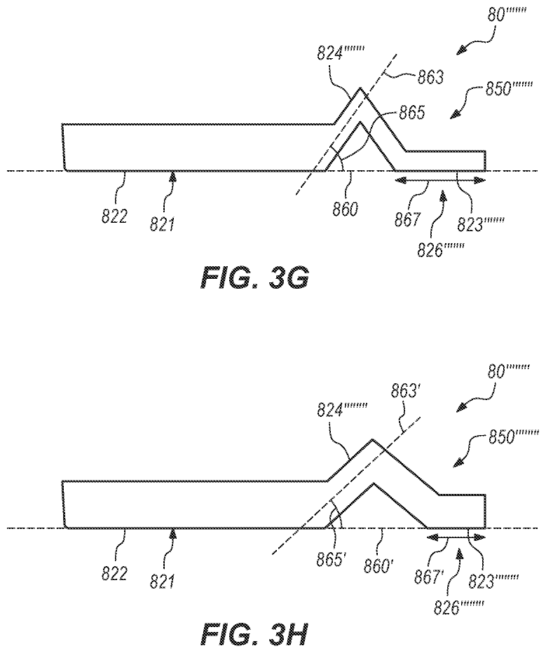

Alternate embodiments of the cover will now be discussed, which differ from the embodiment of the cover 80 depicted in FIGS. 2A through 2D. FIGS. 3A and 3B are cross-sectional side views of possible embodiments of a cover 80′, 80″ for a personal are product, according to the present invention. FIGS. 3C and 3D are cross-sectional side views of possible embodiments of a cover 80′″, 80″″ for a personal are product, according to the present invention. In some embodiments, the covers 80′, 80″, 80′″, 80″″ of FIGS. 3A through 3D are each configured to be used with the personal care product 10. The covers 80′, 80″, 80′″, 80″″ share one or more common features with the cover 80 previously discussed and thus the description of the covers 80′, 80″, 80′″, 80″″ herein will focus on the distinctions between the design of the covers 80′, 80″, 80′″, 80″″ and the cover 80. Like the cover 80 design in FIGS. 2A through 2D, the cover 80′ design of FIG. 3A includes a tab 850′ with a first tab surface 823 that is coplanar with the planar outer surface 822 of the cover 80′. However, unlike the cover 80 design in FIGS. 2A through 2D, the cover 80′ design of FIG. 3A features a second tab surface 824′ that is not parallel with the planar outer surface 822 of the cover 80. Additionally, unlike the cover 80 design in FIGS. 2A through 2D, the cover 80′ design of FIG. 3A is tapered such that a height (between the first tab surface 823 and the second tab surface 824) of the tab 850′ varies along the tab length 852 of the tab 850′. The cover 80″ design of FIG. 3B features a tab 850″ where neither tab surface 823″, 824″ of the tab 850″ is coplanar or parallel with the planar outer surface 822.

In an embodiment, FIG. 3C depicts a cover 80′″ design where the inner rim 830′″ differs from the inner rim 830 of the cover 80. In one embodiment, the inner rim 830′″ defines a cavity 810 and includes a step 840 such that an inner diameter 842 of the cavity 810 varies from a first dimension to a second dimension across the step 840. In an example embodiment, the inner diameter 842 is about 19 mm or in a range from about 6 mm to about 27 mm. In these embodiments of the cover 80′″, the step 840 is configured to engage the portion of the applicator head 11 (e.g., frame 50) positioned within the cavity 810.

In an embodiment, FIG. 3D depicts a cover 80″″ design where a first tab 850a″″ is on a same side of the cover 80″″ as the tab 850′ and tab 850″ of FIGS. 3A and 3B and a second tab 850b″″ is on an opposite side of the cover 80″″. In an example embodiment, the first tab 850a″″ could be used as a stand to support the beauty care product 10 and the second tab 850b″″ could be used for the finger to pull and dislodge the applicator head 11 from the cover 80″″.

FIGS. 3E and 3F are top views of possible embodiments of a cover 80′″″, 80″″″ for a personal care product, according to the present invention. FIGS. 3G and 3H are side perspective views of possible embodiments of a cover 80′″″″, 80″″″″ for a personal care product, according to the present invention. In some embodiments, the covers of FIGS. 3E through 3H are each configured to be used with the personal care product 10. The covers of FIGS. 3E through 3H share one or more common features with the cover 80 previously discussed and thus the description of the covers 80′″″, 80″″″, 80′″″″, 80″″″″ herein will focus on the distinctions with the cover 80. As shown in FIG. 3E, in one embodiment the cover 80′″″ can feature a tab 850′″″ that defines one or more apertures 859. In an example embodiment, the aperture 859 can be sized for various functions. In one example embodiment, the aperture 859 is sized and/or shaped to hang the cover 80′″″ (and beauty care product 10 with the applicator head 11 frictionally engaged within the cavity 810 of the cover 80′″″) at a non-horizontal resting surface (e.g., a wall). In these embodiments, a hook or similar shaped object on the resting surface is passed through the aperture 859 to hang the cover 80′″″ and personal care product 10 at the resting surface. FIG. 3F depicts a similar cover 80″″″ design as FIG. 3E with the exception that a recess 861 (rather than the aperture 859) is formed in the cover 80″″″ and so that multiple tabs 850a″″″, 850b″″″ are provided, with the recess 861 therebetween. In some embodiments, the cover 80″″″ design of FIG. 3F could also be hung in an area by passing an object (e.g., hook on a wall) through the recess 861, where the recess 861 is sized to partially enclose the object such that the cover 80″″″ can be hung in the area.

In some embodiments, FIGS. 3G and 3H depict that the cover 80′″″″, 80″″″″ can include one or more tabs 850′″″″, 850″″″″ that share one or more common characteristics with the tab 850 of the cover 80. In one example embodiment, the tab 850′″″″, 850″″″″ of FIGS. 3G and 3H feature a respective tab base 826′″″″, 826″″″″ that respectively define a first tab surface 823′″″″, 823″″″″ that is coplanar with the planar outer surface 822 of the cover 80′″″″, 80″″″″. However, unlike the cover design of FIGS. 2A through 2D, the first tab surface 823′″″″, 823″″″″ of the respective tab base 826′″″″, 826″″″″ in FIGS. 3G and 3H is spaced apart from the planar outer surface 822 (though still coplanar). In some embodiments, the second tab surface 824′″″″, 824″″″″ of the respective tab 850′″″″, 850″″″″ in FIGS. 3G and 3H may not be parallel with the planar outer surface 822 of the base 821. Additionally, in some embodiments the cover 80′″″″, 80″″″″ designs of FIGS. 3G and 3H have one or more differences. In some embodiments, the second tab surface 824′″″″ of the cover 80′″″″ in FIG. 3G is angled at a steeper angle than the second tab surface 824″″″ of the cover 80″″″ in FIG. 3H. In an example embodiment, an angle 865 formed between an axis 863 defining the second tab surface 824′″″″ and the plane 860 in the cover 80′″″″ design is greater than a corresponding angle 865′ formed between the axis 863′ defining the second tab surface 824″″″″ and the plane 860 in the cover 80″″″. In other embodiments, the first tab surface 823′″″″ of the cover 80′″″″ in FIG. 3G has a different length 867 (e.g., shorter) along the plane 860 relative to the length 867′ of the first tab surface 823″″″″ of the cover 80″″″″ in FIG. 3H.

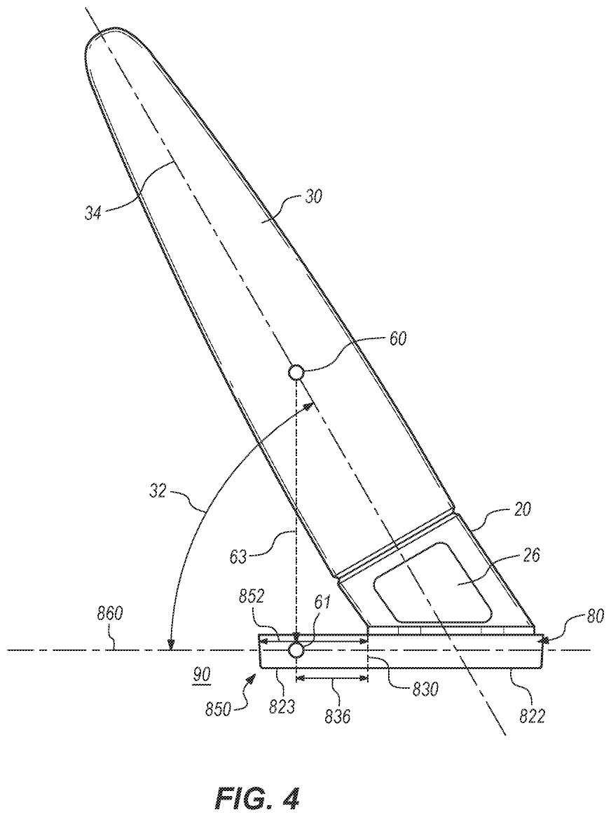

The use of the cover in conjunction with the personal care product will now be discussed. FIG. 4 is a side view of an applicator head cover being used as a stand for a personal care product having a handle and an applicator head, according to the present invention. In some embodiments, FIG. 4 depicts the applicator head cover 80 of FIGS. 2A through 2D being used as a stand for the personal care product 10 of FIGS. 1A through 1C. However, the other cover designs discussed herein can be used in a similar manner as a stand for the personal care product 10.

As shown in FIG. 4, the cover 80 supports the personal care product 10, so that an angle 32 is formed between an axis 34 of the handle 30 and a plane 860 defined by the planar outer surface 822. The handle axis 34 is defined as an axis which extends along a length of the handle 30. In one embodiment, the plane 860 is defined such that it is parallel to the planar outer surface 822. In other embodiments, the cover 80 supports the personal care product 10 such that the angle 32 is formed between the handle axis 34 and the tab 850 (e.g., first tab surface 823), the planar outer surface 822, or both. In one embodiment, when the cover 80 supports the personal care product 10 on a horizontal resting surface 90, the plane 860 is aligned and/or is parallel with the resting surface 90 and thus the angle 32 is also formed between the handle axis 34 and the resting surface 90. In an example embodiment, the angle 32 is in a range from about 10 degrees to about 60 degrees. In an embodiment, the flat treatment sheet 40 secured within the cavity 810 of the cover 80 is aligned parallel to the planar outer surface 822. Thus, in these embodiments the angle 32 is also formed between the handle axis 34 and a plane (e.g., plane 860) that is parallel to the flat treatment sheet 40.

In some embodiments, the cover 80 is configured to support the personal care product 10 as shown in FIG. 4 without the need for additional support (e.g., without additional structure or components to support the personal care product 10 on the resting surface 90 such that the handle axis 34 forms the angle 32 as shown in FIG. 4).

As further shown in FIG. 4, the one or more tabs 850 are integral with the cover 80 and extend beyond the inner rim 830 such that the handle 30 is angled towards the one or more tabs 850. The inventors of the present invention recognized that it would be advantageous to form the tabs 850 such that they are on a same side of the cover 80 that the personal care product 10 (e.g., handle 30) is angled towards, since extending the tab 850 on this side facilitates supporting the personal care product 10 on the resting surface 90.

As shown in FIG. 4, in some embodiments the personal care product 10 includes a center of gravity 60. In some embodiments, the tab length 852 of the one or more tabs 850 is selected based on the center of gravity 60. This selection of the tab length 852 based on the center of gravity 60 advantageously ensures that the cover 80 supports the personal care product 10 as shown in FIG. 4. In one embodiment, FIG. 4 depicts a projection 61 of the center of gravity 60 of the personal care product 10 in the plane 860 (or along the resting surface 90). A length 836 is defined between the projection 61 of the center of gravity 60 in the plane 860 (or along the resting surface 90) and the inner rim 830 (e.g., a most proximate portion of the inner rim 830 to the projection 61) or the portion of the applicator head 11 engaged by the inner rim 830. In some embodiments, the tab length 852 of the one or more tabs 850 is selected to be greater than the length 836 between the center of gravity projection 61 and the inner rim 830. In an example embodiment, the length 836 varies between about 1 mm and about 15 mm whereas the length 852 varies between about 3 mm and about 30 mm. The inventors of the present invention recognized that this condition on the tab length 852 of the one or more tabs 850 facilitates the cover 80 supporting the personal care product 10 as shown in FIG. 4 in a stable manner without the personal care product falling over on a resting surface 90 at an angle 32.

Although the embodiment of FIG. 4 above discussed that the plane 860 is defined by the planar outer surface 822 (e.g., parallel to the planar outer surface 822), in other embodiments the plane 860 is defined by the flat treatment sheet 40 (e.g., secured within the cavity 810 of the cover 80) and/or the planar outer surface 822. In an example embodiment, the plane 860 is defined such that it is parallel to the flat treatment sheet 40 and/or the planar outer surface 822.

As illustrated in FIG. 4, in some embodiments the cover 80 is configured such that when it covers or encapsulates the applicator head 11 of the personal care product 10, it does not obstruct the one or more windows 26 of the housing 20. The inventors of the present invention recognized that this advantageously facilities moisture evaporation from the applicator head 11 (e.g., flat treatment sheet 40) when the cover 80 supports the personal care product 10.

Cross-sectional views of the interface between the cover 80 and the applicator head 11 will now be discussed. FIGS. 5A and 5B are side cross-sectional views of the applicator head cover 80 and the personal care product 10 of FIG. 4, according to the present invention. The tab 850 has a second tab surface 824 that is not coplanar with the planar outer surface 822 of the base 821. In an example embodiment, the second tab surface 824 is oriented parallel with the planar outer surface 822. However, in other embodiments, the second tab surface 824 is neither coplanar nor parallel with the planar outer surface 822. As shown in FIGS. 5A and 5B, in some embodiments when the applicator head 11 is received within the cavity 810 and engaged by the cover 80, the planar inner surface 822 is aligned parallel with the flat treatment sheet 40. In some embodiments, FIGS. 5A and 5B depict that the inner rim 830 frictionally engages the portion of the applicator head 11 (e.g., frame 50). Additionally, FIGS. 5A and 5B depict that in some embodiments the cavity 810 defines the planar inner surface 820 that is configured to receive the applicator head 11.

FIG. 5C is a side cross-sectional view showing a gap 811 between the applicator head cover 80 and the personal care product 10 of FIG. 4, according to the present invention. In some embodiments, an outer dimension of the applicator head 11 is less than an inner dimension of the cavity 810 such that a small gap 811 is provided between the inner rim 830 and the applicator head 11. In an example embodiment, the gap 811 is less than about 0.3 mm and more specifically less than about 0.15 mm. However, in other embodiments the outer dimension of the applicator head 11 is equal to or greater than the inner dimension of the cavity 810 such that the frictional engagement between the inner rim 830 and the applicator head 11 is achieved by the applicator head 11 pressing against the inner rim 830.

The illustrations presented herein are not intended to be actual views of any particular cover, stand, apparatus (e.g., device, system, etc.), or method, but are merely idealized and/or schematic representations that are employed to describe and illustrate various embodiments of the disclosure.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm” or +10% of the disclosed dimension.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A personal care product comprising:
an applicator head comprising a flat treatment sheet;
a cover configured to surround said applicator head and to cover said treatment sheet, said cover comprises;
a base including a planar outer surface that defines a plane that is parallel to the planar outer surface,
an outer rim around a perimeter of said planar outer surface and an inner rim configured to frictionally engage a portion of said applicator head, and
one or more tabs integral with said cover and extending along the plane by a tab length beyond the inner rim,
wherein said personal care product comprises a center of gravity with a projection in the plane, wherein the tab length of the one or more tabs along the plane exceeds a length between the projection and the inner rim along the plane.

2. The personal care product of claim 1 wherein said cover of said personal care product is in contact with a resting surface and is configured to support said personal care product standing on said resting surface without additional support.

3. The personal care product of claim 2, further comprising a housing and a handle, wherein said personal care product standing on said resting surface is disposed such that the handle is oriented at an angle relative to said planar outer surface of said cover, said one or more tabs, or both.

4. The personal care product of claim 3 wherein said angle ranges from about 10 degrees to about 60 degrees.

5. The personal care product of claim 4, wherein a weight of the personal care product varies from about 10 grams to about 50 grams.

6. The personal care product of claim 1, wherein the flat treatment sheet further defines the plane such that the plane is parallel to both the flat treatment sheet and the planar outer surface.
